(19) United States
(12) Patent Application Publication
(10) Pub. No.: US 2008/0217118 A1
(43) Pub. Date: Sep. 11, 2008

(54) Bellows for a Self-Amplifying Electromechnical disc Brake and Disc Brake with Such a Bellows

(76) Inventors: Chi-Thuan Cao, Korntal-Muenchingen (DE); Dietmar Baumann, Hemmingen (DE); Dirk Hofmann, Stuttgart (DE); Herbert Vollert, Vaihingen/Enz (DE); Willi Nagel, Remseck/Hochdorf (DE); Andreas Henke, Diemelstadt (DE); Bertram Foitzik, Ilsfeld (DE); Bernd Goetzelmann, Sindelfingen (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 11/997,251

(22) PCT Filed: Jun. 14, 2006
(86) PCT No.: PCT/EP2006/063199

§ 371 Date: Jan. 29, 2008

(30) Foreign Application Priority Data
Jul. 29, 2005 (DE) 102005035597.8

(51) Int. Cl. F16D 55/225; F16D 65/00

(52) U.S. Cl. 188/72.2; 188/73.31

(57) ABSTRACT

The invention relates to a bellows for a self-energising electromechanical disc brake. According to the invention, a low deformation force may be achieved by means of a bellows with an elliptical, offset cross-section tapering in one direction and, in opposing circumferential sections of the bellows, the provision of circumferential folds of small curvature and inclined folds along the longitudinal sides of the bellows.

### PRIOR ART

The invention relates to a bellows for a self-amplifying electromechanical disc brake with the features of the preamble to claim 1. The invention also relates to a self-amplifying electromechanical disc brake equipped with such a bellows according to the preamble to claim 11.

Intrinsically known disc brakes come in a virtually countless variety of designs. Currently, hydraulic disc brakes are the standard in the automotive field. A comparatively recent addition to these are electromechanical disc brakes whose friction brake pads are pressed against a brake disc by an electric motor via a rotation/translation converting transmission in order to actuate the disc brake. Normally, a reduction gear train is connected between the electric motor and the rotation/translation converting transmission. In many cases, the rotation/translation converting transmission is a screw mechanism, but the rotation/translation converting transmission can also be a cam or the like, for example, which the electric motor pivots via the reduction gear train, causing it to press the friction brake pad(s) against the brake disc.

There are also known electromechanical disc brakes that are equipped with a mechanical or other form of self-amplifying device that converts a braking force and friction force, which the rotating brake disc exerts on the friction brake pad(s) being pressed against it during braking, into a compressive force that presses the friction brake pads against the brake disc in addition to the compressive force exerted by electric motor.

Known electromechanical disc brakes with mechanical self-amplification have a pad support plate that is situated parallel to the brake disc on one side of the brake disc and whose front side oriented toward the brake disc supports a friction brake pad. The pad support plate, together with the friction brake pad, is moved both transversely and parallel to the brake disc in order to actuate the disc brake, i.e. in order to apply the brakes. In order to protect the mechanisms of the self-amplifying device and the electromechanical actuating device, it is known to use a bellows that encloses an intermediate space between the pad support plate and the brake caliper. The subject of the invention is such a bellows for a self-amplifying electromechanical disc brake.

### EXPLANATION AND ADVANTAGES OF INVENTION

The bellows according to the invention, with the defining characteristics of claim 1, has a noncircular, rounded cross section. Curvature radii in two opposing circumference sections of the cross section of the bellows are less than half the distance of the two circumference sections from each other. A preferred shape of the cross section of the bellows is an ellipse or at any rate, an approximate ellipse (claim 2). Other possible cross-sectional shapes for the bellows according to the invention include an ellipse deformed toward an oval shape or an actual oval. The longitudinal sides of the bellows can be curved or straight; it is also possible for one or both of the longitudinal sides to be curved inward. In the case of straight longitudinal sides, the cross section of the bellows is an oval. The cross section of the bellows does not absolutely have to be symmetrical; in this case, the cross section deviates from the mathematical form of an ellipse or an oval. The bellows according to the invention thus has an elongated form with rounded narrow ends; the longitudinal sides can also be rounded as stated above or can be straight. The curvature radii can change in the circumference direction.

The elongated form of the bellows is adapted to self-amplifying electromechanical disc brakes whose pad support plates usually have a greater span in the circumference direction of the brake disc than in the radial direction in relation to the brake disc. The intermediate space between the pad support plate and the brake caliper as well as the mechanisms that are to be protected from moisture and contamination can be enclosed in a space-saving fashion by the shape of the bellows according to the invention. The bellows also permits a movement of the pad support plate in relation to the brake caliper, both parallel and transversely in relation to the brake disc. The bellows according to the invention also compensates for a pivoting motion of the pad support plate, i.e. a deviation from parallelism with the brake disc. The bellows according to the invention is consequently adapted to the movement of the pad support plate of a self-amplifying electromechanical disc brake in relation to its brake caliper. The invention makes it possible to achieve a bellows that is short or small in the axial direction, i.e. in the direction perpendicular to the cross section.

Advantageous embodiments and modifications of the invention disclosed in claim 1 are the subject of the dependent claims.

The disc brake with the defining characteristics of claim 11 has a bellows of the type described above. An explanation of the disc brake has already been given above in the preceding explanation of the bellows and in the explanation of self-amplifying electromechanical disc brakes; to avoid repetition, reference is hereby made to the preceding explanations.

### DRAWINGS

The invention will be explained in greater detail below in conjunction with an exemplary embodiment shown in the drawings.

FIG. 1 shows a disc brake with a bellows according to the invention, viewed in the axial direction of a brake disc;

FIG. 2 is a cross section of the bellows along the line II-II in FIG. 1; and

FIG. 3 is an enlarged depiction of the detail III in FIG. 1.

### DESCRIPTION OF THE EXEMPLARY EMBODIMENT

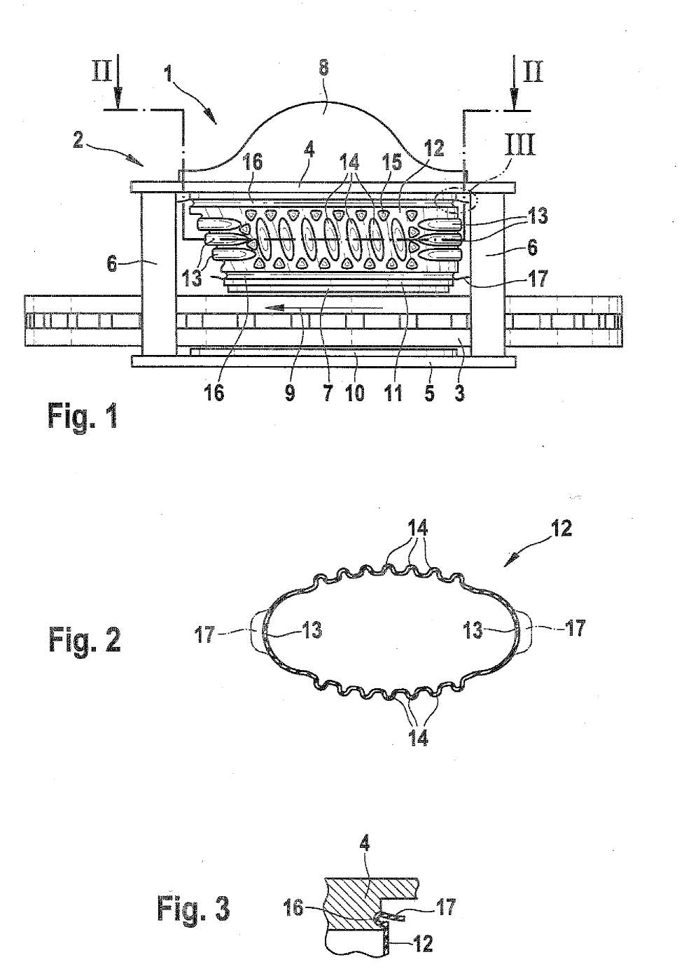

The self-amplifying electromechanical disc brake 1 shown in FIG. 1 has a brake caliper 2 that is embodied in the form of a floating caliper, i.e. it is able to move transversely in relation to a brake disc 3 with guides that are not visible in the drawing. In the exemplary embodiment of the invention shown and described here, the brake caliper 1 is a frame caliper with two brake caliper plates 4, 5 that are connected to each other by means of anchors 6. The brake caliper plates 4, 5 are situated on both sides of the brake disc 3 and are parallel to each other and to the brake disc 3. The anchors 6 connect the brake caliper plates 4, 5 transversely in relation to the brake disc 3, outside of a circumference of the brake disc 3. The anchors 6 are situated approximately in the central longitudinal planes of the brake caliper plates 4, 5 so that they are essentially subjected only to tension when the disc brake 1 is actuated. The guides for the transversely moving guidance of the brake caliper 2, which is embodied as a floating caliper, are situated beneath the anchors 6 in FIG. 1 and are therefore not visible. The brake caliper plates 4, 5 and the anchors 6 of the brake caliper 2 can be integrally joined to one another or can be embodied as separate parts that are then assembled.

The disc brake 1 has an electromechanical actuating device, not visible in the drawing, which has an electric motor, a reduction gear train, and a rack-and-pinion drive and which is able to move a friction brake pad 7 at an acute angle and in a circumference direction in relation to the brake disc 3 in order to actuate the disc brake 1. The friction brake pad 7 is moved on an imaginary helical path around the rotation axis of the brake disc 3. The actuating device is accommodated in a motor and transmission housing 8 and is therefore not visible. The motor and transmission housing 8 is attached to an outer side of the one brake caliper plate 4 of the brake caliper 2, oriented away from the brake disc 3. Such electromechanical actuating devices for electromechanical disc brakes are intrinsically known to those skilled in the at and, since the electromechanical actuating device is not the actual subject of the invention, need not be explained in greater detail here.

The disc brake 1 has a mechanical self-amplifying device that is not visible in the drawing and that includes a ramp mechanism. The ramp mechanism guides the friction brake pad 7 on the above-explained helical path around the rotation axis of the brake disc 3, at an acute angle in relation to the brake disc 3 and in the circumference direction in relation to the brake disc 3. If the electromechanical actuating device presses the friction brake pad 7 against the brake disc 3 in order to actuate the disc brake 1, the brake disc 3 exerts a friction force on the friction brake pad 7 in the circumference direction, in the rotation direction of the brake disc 3. The assumed rotation direction is indicated with the arrow 9 in FIG. 1. Due to the so-called the wedge principal, the support of the friction brake pad 7 by means of the ramps, which are not visible in the drawing and extend at an acute angle in relation to the brake disc 3, generates a force with a component oriented transversely in relation to the brake disk 3, which presses the friction brake pad 7 against the brake disc 3 in addition to a compressive force exerted by the electromechanical actuating device. This amplifies the braking force of the disc brake 1. Ramp mechanisms of this kind are intrinsically known to those skilled in the art and, since the ramp mechanism is not those skilled in the art and, since the ramp mechanism is not the actual subject of the invention, need not be explained in greater detail here.

On the opposite side from the one friction brake pad 7, a second friction brake pad 10 is situated on an inner side of the brake caliper plate 5 on the brake caliper 2, oriented toward the brake disc 3. If the electromagnetic actuating device presses the one friction brake pad 7 against the one side of the brake disc 3 in the above-described fashion in order to actuate the disc brake 1, then the brake caliper 2 is moved transversely in relation to the brake disc 3 and presses the other friction brake pad 10 against the other side of the brake disc 3 so that both friction brake pads 7, 10 brake the brake disc 3.

The one friction brake pad 7 is situated on a pad support plate 11 that is situated spaced apart from the one brake caliper plate 4 of the brake caliper 2 and parallel to the brake disc 3. In an intermediate space between the pad support plate 11 and the brake caliper plate 4, a bellows 12 according to the invention is provided, which encompasses the parts of the self-amplifying device and the electromechanical actuating device 1—to the extent that they are situated in the intermediate space between the pad support plate 11 and the brake caliper plate 4—and protects them from moisture and contamination. The bellows 12 covers the ramp mechanism and, together with the motor and transmission housing 8, covers the actuating device, which is why the ramp mechanism and the actuating device are not visible in the drawing.

The bellows 12 is tubular and has an at least approximately elliptical cross section. The cross section of the bellows 12 decreases in one direction, namely in the direction of the pad support plate 11. In addition, the bellows 12 extends in a diagonal fashion; it is inclined in opposition to the predetermined rotation direction 9 of the brake disc 3. The basic shape of the bellows 12 is thus approximately an outer surface of a truncated, slanted pyramid with an elliptical cross section. Deviations from the above-described shape of the bellows 12 are possible, for example the cross section of the bellows 12 can be changed to an oval or to a shape similar to an oval, the cross section can be constant over the axial span of the bellows 12, and/or the bellows 12 can be straight instead of slanting. If the friction brake pad 7 with the pad support plate 11 is moved in the rotation direction 9 of the brake disc 3 during actuation of the disc brake 2, then the slanting of the bellows 12 decreases; under some circumstances, the deformation can cause the bellows 12 to straighten up or even become slanted in the opposite direction. The “basic shape” of the bellows 12 is understood to mean its shape without its folds, which will be explained below, and without its connections to the brake caliper plate 4 and the pad support plate 11. FIG. 2 shows the cross section of the bellows 12 at the plane indicated by the section line II-II in FIG. 1. The following shows only the cross section in the indicated intersecting plane and not regions of the bellows 12 and the disc brake 1 that are situated behind the intersecting plane. An axial span of the bellows 12 is short in relation to its cross-sectional area; for example, the axial span lies between approx. ¼ and ½ of an imaginary long semiaxis of the elliptical cross section.

Extending in its circumference direction, the bellows 12 has parallel circumference folds 13 in the region of the opposing circumference sections with small curvature. The circumference sections with small curvature and the circumference folds 13 are situated in the regions intersected by the imaginary long semiaxis of the elliptical cross section of the bellows 12. On the long sides between the above-mentioned opposing circumference sections with small curvature, the bellows 12 has diagonal folds 14 that extend diagonally in relation to imaginary cross-sectional planes of the bellows 12. The diagonal folds 14 can be parallel to one another, but do not have to be. The reason for the diagonal orientation of the diagonal folds 14 is as follows: when the disc brake 1 is actuated, the pad support plate 11 with the friction brake pad 7 is moved on the above-explained helical path around the rotation axis of the brake disc 3. The pad support plate 11 thus moves parallel to and transversely in relation to the brake disc 3. The movement parallel to the brake disc 3 occurs in the rotation direction 9. The distance of the pad support plate 11 from the brake caliper plate 4 of the brake caliper 2 thus increases, the bellows 12 is stretched axially and simultaneously straightened up, thus reducing its slant. The inclination of the diagonal folds 14 is selected so that when the above-mentioned movement occurs, they execute a pivoting motion and their slanting decreases. The increase in the distance of the pad support plate 11 from the brake caliper plate 4 upon actuation of the disc brake 1 is at least partially compensated for by the above-explained pivoting of the diagonal folds 14; the diagonal folds 14 require no stretching or at least require less stretching than would be the case with a longitudinal span of the diagonal folds 14 perpendicular to the imaginary cross-sectional planes of the bellows 12. Upon actuation of the disc brake 1, the bellows 12 is thus easier to deform in the necessary direction (and in the opposite direction from this).

The circumference folds 13 and diagonal folds 14 taper toward their ends, which improves the deformability of the bellows 12 and reduces its resistance to deformation. In the region of the tapered ends of the circumference folds 13 and diagonal folds 14, the bellows 12 has dome-shaped folds 15 that further improve the deformability of the bellows 12 and reduce the resistance to deformation because they provide additional deformable material in regions of the bellows 12 in which the circumference folds 13 and diagonal folds 14 move in pivoting fashion in relation to each other. The shape of the dome-shaped folds 15 is adapted to the regions between the tapering ends of the circumference folds 13 and diagonal folds 14 in which the dome-shaped folds 15 are situated. In the exemplary embodiment of the invention depicted and described here, the dome-shaped folds 15 have an approximately triangular base area with rounded corners and convex sides of the triangle.

The bellows 12 is comprised of silicone, i.e. a rubber-like plastic. The shape of the bellows 12 and the design and placement of its folds 13, 14, 15 are selected with a view to keeping deforming forces as low as possible and preventing the folds 13, 14, 15 of the bellows 12 from catching in the mechanical parts of the self-amplifying device and the actuating device of the disc brake 1, even when the bellows 12 encompasses the self-amplifying device and the actuating device in a space-saving fashion, i.e. snugly in at least some places.

The end edges 16 of the bellows 12 are fastened to the brake caliper plate 4 of the brake caliper 2 at one end and to the pad support plate 11 at the other. For this purpose, the end edges 16 are embodied as circumferential rounded beads that protrude inward and engage in corresponding circumferential grooves in the brake caliper plate 4 and the pad support plate 11. FIG. 3 is an enlarged view of the one end edge 16 of the bellows 12 and its engagement in the circumferential groove in the brake caliper plate 4. In order to form the circumferential bead, the end edges 16 are thus embodied as first protruding inward and then protruding outward. It is also possible to embody the beads of the end edges 16 of the bellows 12 as protruding outward (not shown) so that they embrace a circumferential bead of the brake caliper plate 4 and the pad support plate 11. Belts, wires, pipe clamps, or the like can be inserted into the beads of the end edges 16 of the bellows 12 and secured in place, but this is not the case in the exemplary embodiment depicted and described here.

To facilitate installation and removal, the end edges 16 of the bellows 12 are provided with tabs 17 that make it possible to grasp the end edges 16 of the bellows 12. In the exemplary embodiment depicted and described here, two mounting tabs 17 are provided on each end edge 16, namely in the opposing circumference sections of the bellows 12 with the small curvature radii. The location of the mounting tabs 17 is indicated with dot-and-dash lines in FIG. 2.

The goal is to achieve a bellows 12 that behaves is a slack fashion during the above-described deformation when the disc brake 1 is actuated or that has a low deformation force; at the same time, the bellows 12 must have enough dimensional stability to prevent the bellows 12 from coming between the moving parts of the self-amplifying device or the actuating device.

1-11. (canceled)

12. A bellows for a self-amplifying electromechanical disc brake, the bellows having opposed open ends and a noncircular, rounded cross section whose curvature radii in two opposing circumferential sections is less than half the distance of the two circumferential sections from each other.

13. The bellows as recited claim 12, wherein the bellows has an elliptical cross section.

14. The bellows as recited claim 12, wherein the bellows has different-sized across sections at its two ends.

15. The bellows as recited claim 12, wherein the bellows is slanted.

16. The bellows as recited claim 12, wherein the bellows comprises diagonal folds that diagonally intersect imaginary cross-sectional planes of the bellows.

17. The bellows as recited claim 12, wherein in the region of its circumferential sections with the small curvature radii, the bellows has circumferential folds that extend approximately parallel to its end edges.

18. The bellows as recited claim 16, wherein in the region of its circumferential sections with the small curvature radii, the bellows has circumferential folds that extend approximately parallel to its end edges.

19. The bellows as recited claim 12, wherein the bellows has folds that taper toward their ends.

20. The bellows as recited claim 16, wherein the bellows has folds that taper toward their ends.

21. The bellows as recited claim 17, wherein the bellows has folds that taper toward their ends.

22. The bellows as recited claim 16, wherein the bellows has dome-shaped folds in the region between the tapered ends of the folds.

23. The bellows as recited claim 17, wherein the bellows has dome-shaped folds in the region between the tapered ends of the folds.

24. The bellows as recited claim 18, wherein the bellows has dome-shaped folds in the region between the tapered ends of the folds.

25. The bellows as recited claim 19, wherein the bellows has dome-shaped folds in the region between the tapered ends of the folds.

26. The bellows as recited claim 12, wherein the bellows has an end edge that protrudes inward or outward.

27. The bellows as recited claim 12, wherein that the bellows has at least one mounting tab.

28. The bellows as recited claim 26, wherein that the bellows has at least one mounting tab.

29. A self-amplifying disc brake, comprising a brake caliper, a pad support plate that is able to move parallel to and transverse to the brake disc, and a bellows that encloses an intermediate space between the pad support plate and the brake caliper, the bellows having a noncircular, rounded cross section whose curvature radii in two opposing circumferential sections is less than half the distance of the two circumference sections from each other.
